(19) United States
(12) Patent Application Publication
(10) Pub. No.: US 2022/0413194 A1
(43) Pub. Date: Dec. 29, 2022

(54) DIFFRACTIVE OPTICAL ELEMENT

(71) Applicant: HIMAX TECHNOLOGIES LIMITED, Tainan City (TW)

(72) Inventor: Jin-Jhih Lu, Tainan City (TW)

(21) Appl. No.: 17/362,922

(22) Filed: Jun. 29, 2021

(51) Int. Cl. G02B 5/18

(52) U.S. Cl. CPC G02B 5/1819; G02B 2005/1804

(57) ABSTRACT

A diffraction optical element is disclosed. The diffraction optical element includes a substrate and multiple grating units. The grating units are disposed above the substrate. The grating units diffract incident light to generate diffracted light being passing through the substrate. A refractive index of the substrate is substantially below 1.45.

### BACKGROUND

### Description of Related Art

The diffractive optical element (DOE) is a specific patterned fine structure designed according to the diffraction theory of the electromagnetic wave and Fourier optics. The patterned structure operates as a manipulator of the amplitude and phase of the electromagnetic wave and/or an apparatus, for example, including, a splitter, a diffuser, or a manipulator of the incident light in order to obtain detailed information for 3-dimentional sensing.

However, an optical structure having a high efficiency for specific light shape has been a great challenge in the art due to both of the limited capacity of DOE design software and geometric structure of DOE.

### SUMMARY

One aspect of the present disclosure is to provide a diffraction optical element. The diffraction optical element includes a substrate and multiple grating units. The grating units are disposed above the substrate. The grating units diffract incident light to generate diffracted light being passing through the substrate. A refractive index of the substrate is substantially below 1.45.

In some embodiments, the diffraction optical element further includes a first layer that is sandwiched between the grating units and the substrate and extends below each of the grating units. The first layer has a first refractive index that is substantially below 1.45.

In some embodiments, a thickness of the first layer is associated with the first refractive index.

In some embodiments, the diffraction optical element further includes a second layer sandwiched between the first layer and the substrate. The second layer has a second refractive index different from the first refractive index.

In some embodiments, the diffraction optical element further includes a layer that is patterned to be disposed between each two of the grating units and disposed on a surface of the substrate. A refractive index of the layer is substantially below 1.45.

In some embodiments, the diffraction optical element further includes multiple layers disposed between the grating units and the substrate. At least half of the layers have a refractive index substantially below 1.45.

In some embodiments, the layers include layers of magnesium fluoride (MgF₂), silicon dioxide (SiO₂), or the combinations thereof.

In some embodiments, the diffraction optical element further includes a layer extending below each of the grating units. The layer includes magnesium fluoride (MgF₂), silicon dioxide (SiO₂), or the combinations thereof.

Another aspect of the present disclosure is to provide a diffraction optical element. The diffraction optical element includes a glass substrate, a first layer disposed on the glass substrate, and a periodic structure disposed on the first layer. The first layer has a first refractive index that is substantially below 1.45. The glass substrate, the first layer, and the periodic structure diffract incident light from a first side of the glass substrate to generate diffracted light at a second side, opposite of the first side, of the glass substrate.

In some embodiments, the first layer includes magnesium fluoride (MgF₂) or silicon dioxide (SiO₂), and has a thickness of about 200 nanometers.

In some embodiments, the diffraction optical element further includes a second layer sandwiched between the first layer and the glass substrate. The second layer has a second refractive index different from the first refractive index.

In some embodiments, the first and second layers include layers of magnesium fluoride (MgF₂), silicon dioxide (SiO₂), or the combinations thereof.

In some embodiments, the first layer has a first thickness and the second layer has a second thickness different from the first thickness.

In some embodiments, the glass substrate has a second refractive index. The diffraction optical element further includes a second layer sandwiched between the first layer and the glass substrate. The second layer has a third refractive index. The first to third refractive indices are different from each other and substantially below 1.45.

In some embodiments, the diffraction optical element further includes a second layer sandwiched between the first layer and the periodic structure. The first layer includes magnesium fluoride (MgF₂) and the second layer includes silicon dioxide (SiO₂).

In some embodiments, the diffraction optical element further includes an adhesion film formed between the first layer and the periodic structure. The adhesion film has a refractive index that is below 1.45.

Another aspect of the present disclosure is to provide a method of forming a diffraction optical element, and the method includes the following operations: forming a film stack on a substrate that has a refractive index below 1.45; and forming multiple grating units on the film stack. The film stack includes multiple films, and a ratio of a first portion, having a first refractive index, in the films over a second portion, having a second refractive index different from the first refractive index, in the films is above 50%. The first refractive index is below 1.45.

In some embodiments, the forming the film stack includes patterning the film stack according to the structure of the grating units.

In some embodiments, the film stack includes magnesium fluoride (MgF₂), silicon dioxide (SiO₂), or the combinations thereof.

In some embodiments, a thickness of the first portion in the films is twice thicker than a thickness of the second portion in the films.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a diffraction optical element, in accordance with some embodiments of the present disclosure.

FIG. 2 is a schematic diagram of a diffraction optical element, in accordance with some embodiments of the present disclosure.

FIG. 3A is a diagram illustrating the relationship between dots efficiency and a thickness of a layer in a diffraction optical element corresponding to FIG. 2, in accordance with some embodiments of the present disclosure.

FIG. 3B is a diagram illustrating the relationship between dots efficiency and a thickness of a layer of different refractive indices in a diffraction optical element corresponding to FIG. 2, in accordance with some embodiments of the present disclosure.

FIG. 4 is a schematic diagram of a diffraction optical element, in accordance with some embodiments of the present disclosure.

FIG. 5 is a schematic diagram of a diffraction optical element, in accordance with some embodiments of the present disclosure.

FIG. 6 is a flow chart of a method of forming a diffraction optical element, in accordance with some embodiments of the present disclosure.

### DETAILED DESCRIPTION

The spirit of the present disclosure will be discussed in the following drawings and detailed description, and those of ordinary skill in the art will be able to change and modify the teachings of the present disclosure without departing from the spirit and scope of the present disclosure.

It should be understood that, in this document and the following claims, the terms “first” and “second” are to describe the various elements. However, these elements should not be limited by these terms. These terms are used to distinguish one element from another. For example, a first element may be termed a second element. Similarly, a second element may be termed a first element without departing from the spirit and scope of the embodiments.

It should be understood that, in this document and the following claims, the terms “include,” “comprise,” “having” and “has/have” are used in an open-ended fashion, and thus should be interpreted to mean “include, but not limited to.” It should be understood that, in this document and the following claims, the term “and/or” includes any and all combinations of one or more of the associated listed items.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. As used herein, the term “and/or” includes any and all combinations of one or more of the associated listed items.

As used herein, “around”, “about”, “approximately” or “substantially” shall generally refer to any approximate value of a given value or range, in which it is varied depending on various arts in which it pertains, and the scope of which should be accorded with the broadest interpretation understood by the person skilled in the art to which it pertains, so as to encompass all such modifications and similar structures. In some embodiments, it shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

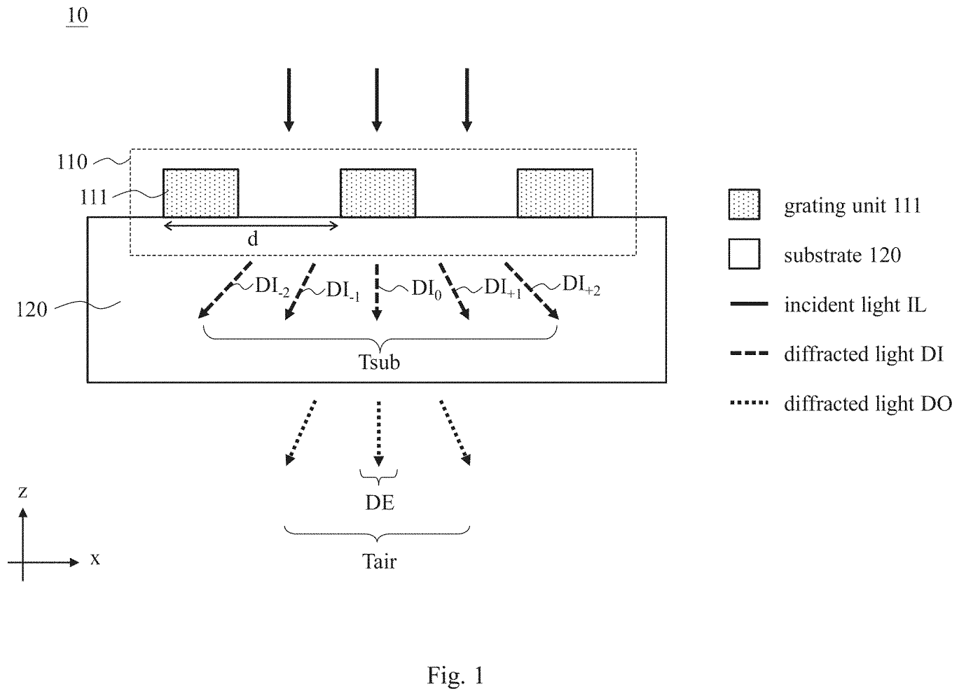

Reference is now made to FIG. 1. FIG. 1 is a schematic diagram of a diffraction optical element 10, in accordance with some embodiments of the present disclosure. For illustration, the diffraction optical element 10 includes a periodic structure 110 and a substrate 120. The periodic structure 110 is disposed on a surface of the substrate 120. In some embodiments, the diffraction optical element 10 is a binary dots diffraction optical element.

In some embodiments, as shown in FIG. 1, the periodic structure 110 includes multiple grating units 111 disposed periodically with a grating pitch d. In various embodiments, the grating units 111 includes one-dimensional (along x direction) rectangular gratings that are fabricated with the grating pitch d which is smaller than the wavelength of the incident light IL(used wavelength.) In various embodiments, the grating pitch d is about 250 nanometers.

The substrate 120 is a substrate having a refractive index n1 that is below 1.45. in some embodiments, the substrate 120 is a silicon, silicon-containing, glass substrate, or a substrate of any other suitable materials that has a refractive index below 1.45. The substrate may be a bare substrate or have one or more layers of material deposited thereon and/or features formed therein. The values associated with and configurations of the substrate 120 are given for illustrative purposes. Various implements are within the contemplated scope of the present disclosure. For example, in some embodiments, the refractive index of the substrate 120 ranges between 1.40 to 1.5.

With reference to FIG. 1, the incident light IL is incident and passes the periodic structure 110. The grating units 111 of the periodic structure 110 are configured to diffract the incident light IL and to generate diffractive light Dl into the substrate 120 in various diffraction directions. In some embodiments, the diffractive light Dl includes m order light beams, in which m is zero, positive integer or negative integer, resulting in diffracted orders on both sides of a zero order beam Dl₀, as shown in FIG. 1. For example, the diffractive light Dl includes light beams of minus two order Dl₋₂ to plus two order Dl₊₂. In addition, the grating pitch d needs to be sufficiently small compared to the wavelength of the incident light IL. More specifically, the grating pitch d satisfies an equation (1):

d·sin θ·n3=mλ (1)

in which the symbol d is the grating pitch d, the symbol θ is the angle of incidence, the symbol n1 is the refractive index of the substrate 120, and the symbol λ is the wavelength of the incident light IL.

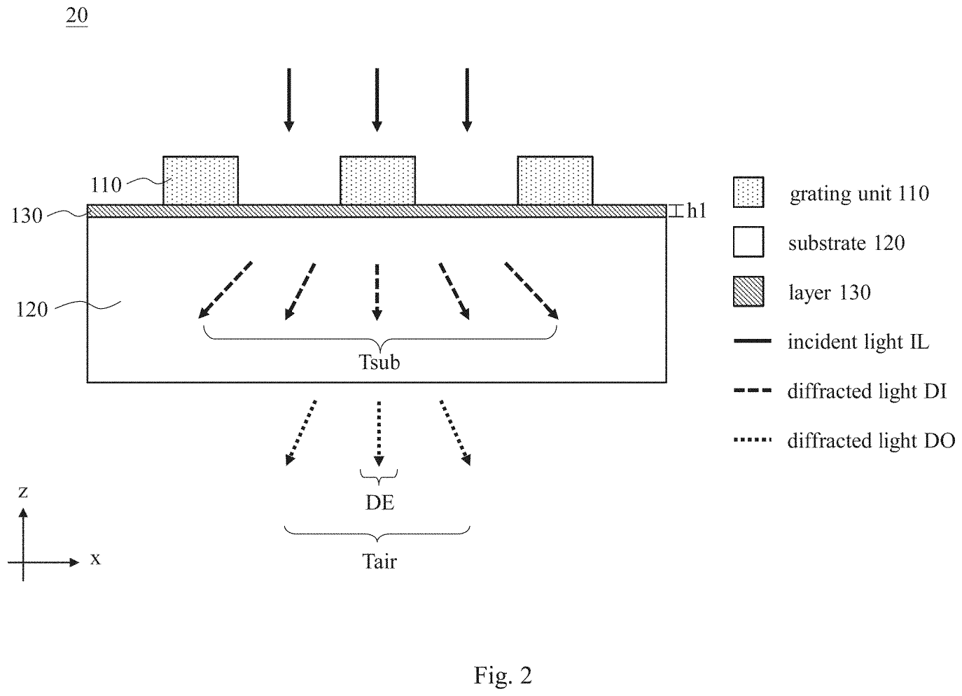

Furthermore, in some embodiments, the diffraction optical element 10 is placed in the air. Compared with some approaches implementing a substrate having a highly refractive index (e.g., more than 1.5), the transmittance Tsub of the present disclosure is improved because the substrate 120 having the lower refractive index reduces the higher order diffraction light beams. Alternatively stated, the intensity of the zero order beam Dl₀ raises while the intensity of higher order beams shrinks. The dots efficiency (denoted as DE for explanation in FIG. 2) associated with the transmittance of the zero order beam Dl₀ in the air increases correspondingly while the transmittance Tair indicates the transmittance of the diffractive light DO propagating out from the substrate 120 to the air. To explain in another way, the dots efficiency is inversely proportional to the refraction index of the substrate 120. For instance, the dots efficiency of the substrate 120 having the refractive index 1.5 is approximately 78.10%, while the dots efficiency of the substrates 120 in some embodiments having the refractive indices 1.45 and 1.40, is about 78.30% and 78.62% respectively.

In addition, with the configurations of the present disclosure, the non-uniformity and diffraction patterns of the diffraction optical element 10 maintain as the refractive index of the substrate 120 decreases, compared with the aforementioned approaches.

The configurations of FIG. 1 are given for illustrative purposes. Various implements are within the contemplated scope of the present disclosure. For example, in some embodiments, the period p is substantially different from 250 nanometers.

Reference is now made to FIG. 2. FIG. 2 is a schematic diagram of a diffraction optical element 20, in accordance with some embodiments of the present disclosure. With respect to the embodiments of FIG. 1, like elements in FIG. 2 are designated with the same reference numbers for ease of understanding. The specific operations of similar elements, which are already discussed in detail in above paragraphs, are omitted herein for the sake of brevity, unless there is a need to introduce the co-operation relationship with the elements shown in FIG. 2.

Compared with FIG. 1, the diffraction optical element 20 in FIG. 2 further includes a layer 130. For illustration, the grating units 111 of the periodic structure 110 is disposed on the layer 130, and the layer 130 is disposed on the substrate 120. Specifically, the layer 130 is sandwiched between each of the grating units 111 and the substrate 120. Alternatively stated, the layer 130 extends below each of the grating units 111 in the embodiments of FIG. 2. Accordingly, the grating units 111 of the periodic structure 110, the substrate 120, and the layer 130 are configured to diffract the incident light IL from a first side of the substrate 120 to generate the diffractive light Dl and the diffractive light DO at a second side, opposite of the first side, of the substrate 120.

The layer 130 has a refractive index n2 that is substantially below 1.45. In some embodiments, the layer 130 is formed as a coating film on the substrate 120 before the grating units 111 are formed. In various embodiments, the layer 130 includes a dielectric layer, such like a layers of magnesium fluoride (MgF₂), silicon dioxide (SiO₂), the combinations thereof, or any other suitable materials that has a refractive index below 1.45.

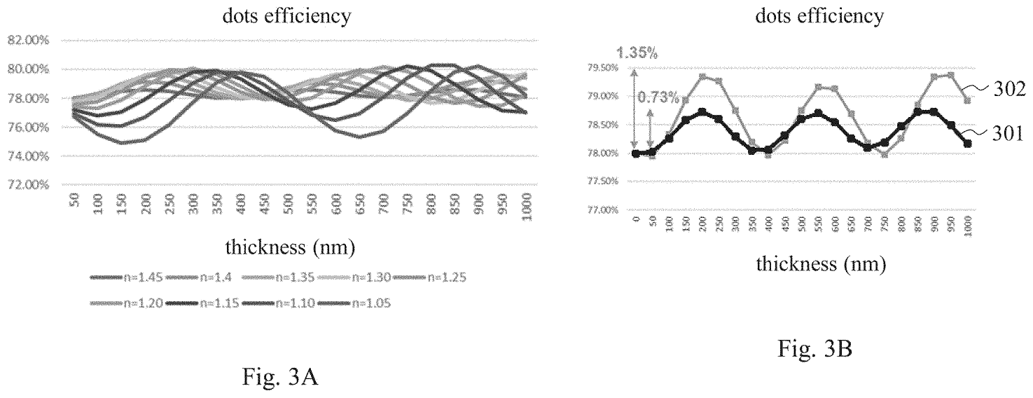

For illustration, the layer 130 has a thickness h1. In some embodiments, the thickness h1 of the layer 130 is associated with the refractive index n2 of the layer 130, as shown in FIGS. 3A-3B.

Reference is now made to FIG. 3A. FIG. 3A is a diagram illustrating the relationship between dots efficiency and the thickness h1 of the layer 130 of different refractive indices in a diffraction optical element corresponding to FIG. 2, in accordance with some embodiments of the present disclosure.

For illustration, curves represent the dots efficiency of various refractive indices and thickness of the layer 130. As shown in FIG. 3A, the dots efficiency alters significantly along with various refractive indices and the thickness h1 of the layer 130. Alternatively stated, in some embodiments, a thickness h1 of the layer 130 is determined according to the refractive index n2 of the layer 130.

Reference is now made to FIG. 3B. FIG. 3B is a diagram illustrating the relationship between the dots efficiency and the thickness h of the layer 130 in the diffraction optical element 20 corresponding to FIG. 2, in accordance with some embodiments of the present disclosure.

As shown in FIG. 3B, a curve 301 corresponds to the layer 130 including silicon dioxide that has a refractive index 1.44. For illustration, the dots efficiency climbs from 78.00% (without coating the layer 130) to about 78.73% (with the thickness h1 being about 200 nm,) with the improvement of 0.73%.

Similarly, a curve 302 corresponds to the layer 130 including magnesium fluoride that has a refractive index 1.38. For illustration, the dots efficiency climbs from 78.00% (without coating the layer 130) to about 79.35% (with the thickness h being about 200 nm,) with the improvement of 1.35%. Based on the disclosure above, the lower the thickness h1 of the layer 130 is, the higher the dots efficiency is improved. Moreover, the transmittance with the substrate 120 coated with the layer 130 of magnesium fluoride (thickness 200 nm) raises 1.16%, compared with the approaches without coating the layer 130.

In addition, a person who is skilled in the art can implement the present disclosure according to the actual practice to determine a preferable thickness h1 of the layer 130. For example, in FIG. 3B, the curve 301 has apexes of the dots efficiency at around the thickness of 200 nm, 550 nm, and 850 nm. The curve 302 has apexes of the dots efficiency at around the thickness of 200 nm, 550 nm, and 900 nm.

With the configurations of the present disclosure, the dots efficiency is improved while the non-uniformity and diffraction patterns of the diffraction optical element 20 maintain as the substrate 120 is coated by the layer 130, compared with the approaches having no coating.

The configurations of FIGS. 2-3B are given for illustrative purposes. Various implements are within the contemplated scope of the present disclosure. For example, in some embodiments, the refractive index n1 of the substrate 120 in the embodiments of FIG. 2 is above 1.45.

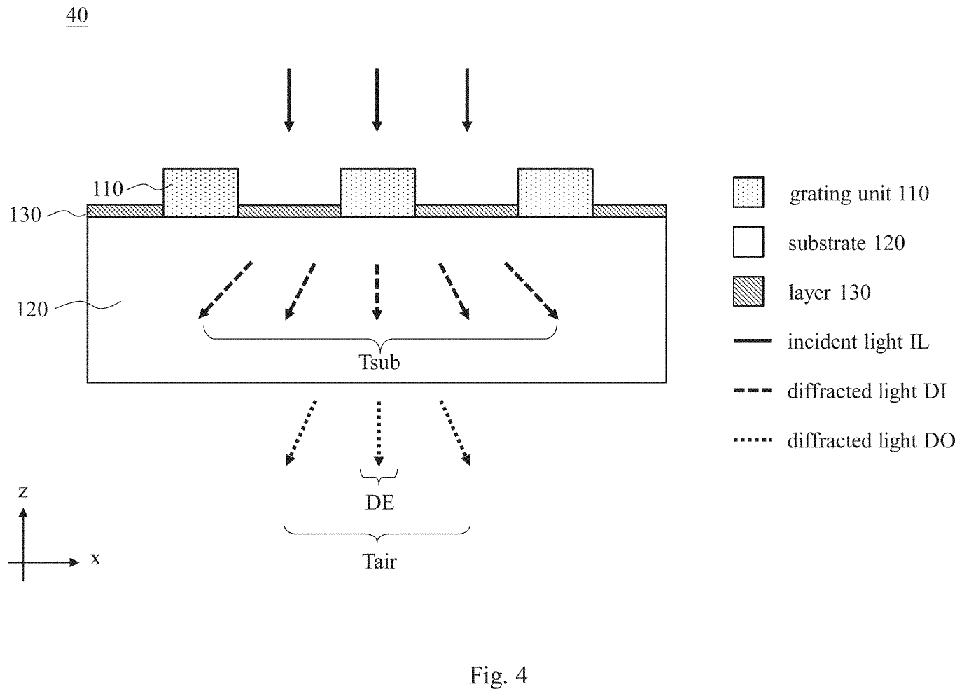

Reference is now made to FIG. 4. FIG. 4 is a schematic diagram of a diffraction optical element 40, in accordance with some embodiments of the present disclosure. With respect to the embodiments of FIGS. 1-3B, like elements in FIG. 4 are designated with the same reference numbers for ease of understanding.

Compared with FIG. 2, the layer 130 of the diffraction optical element 40 is patterned to be disposed between each two of the grating units 111 and is disposed on the surface of the substrate. Alternatively stated, the layer 130 connects two opposite sides, along x direction, of two adjacent grating units 111, without connecting bottom sides of said two adjacent grating units 111. In various embodiments, the layer 130 does not connect top sides of said two adjacent grating units 111.

The configurations of FIG. 4 are given for illustrative purposes. Various implements are within the contemplated scope of the present disclosure.

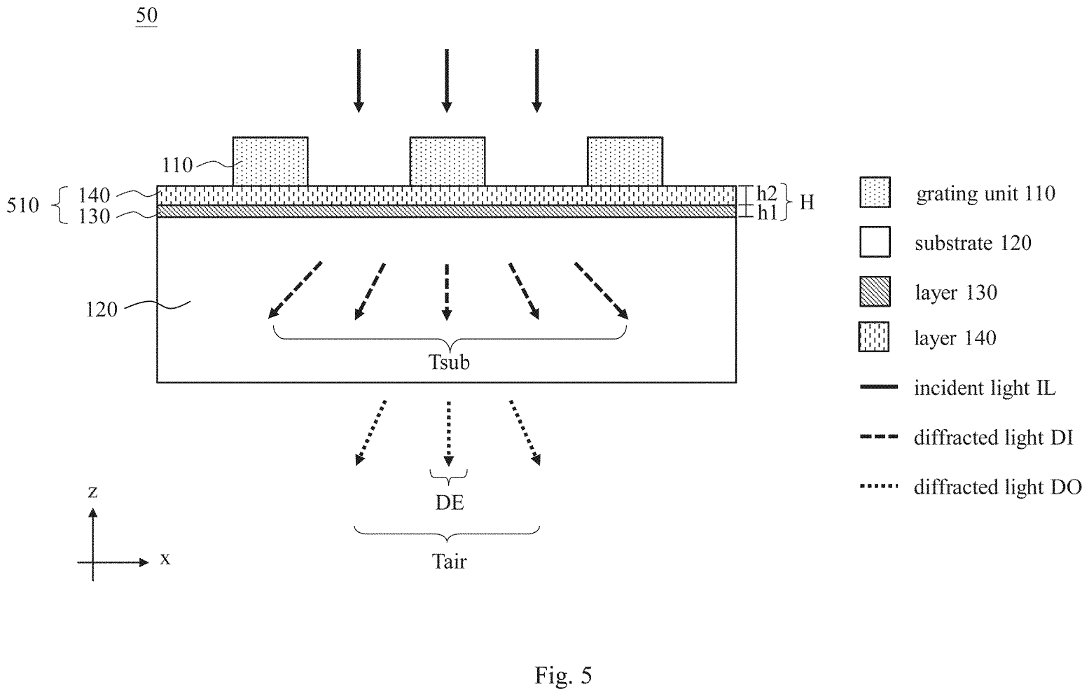

Reference is now made to FIG. 5. FIG. 5 is a schematic diagram of a diffraction optical element 50, in accordance with some embodiments of the present disclosure. With respect to the embodiments of FIGS. 1-4, like elements in FIG. 5 are designated with the same reference numbers for ease of understanding.

Compared with FIG. 2, instead of having single layer in the diffraction optical element 20, the diffraction optical element 50 includes a film stack 510 having the layer 130 and a layer 140 sandwiched between the layer 130 and the grating units 111. In various embodiments, the layer 140 sandwiched between the layer 130 and the substrate 120. Alternatively stated, the diffraction optical element 50 includes multiple layers 130-140 to diffract the incident light IL.

In some embodiments, the layer 140 is configured with respect to, for example, the layer 130. For example, in some embodiments, the layer 140 has a refractive index n3 that is substantially below 1.45. In various embodiments, the layer 140 includes a dielectric layer, such like a layers of magnesium fluoride, silicon dioxide, the combinations thereof, or any other suitable materials that has a refractive index below 1.45. Alternatively stated, the layers 130-140 in the film stack 510 layers of magnesium fluoride, silicon dioxide, the combinations thereof, or any other suitable materials that has a refractive index below 1.45. In addition, in some embodiments, the refractive index n2 of the layer 130 is different from the refractive index n3 of the layer 140. For example, the layer 130 includes magnesium fluoride while the layer 140 includes silicon dioxide. In some embodiments, the layer 140 includes an adhesion film having a refractive index below 1.45. The adhesion film, in some embodiments, includes, for instance, a silicon resin.

For illustration, as shown in FIG. 5, the film stack 510 has a thickness H that is a sum of the thickness h1 of the layer 130 and a thickness h2 of the layer 140. In some embodiments, the thickness h1 is the same as the thickness h2. In various embodiments, the thickness h1 is different from the thickness h2. In various embodiments, the thickness h1 is smaller the thickness h2.

With reference to FIGS. 1-5, in some embodiments, the refractive index n1 of the substrate 120, the refractive index n2 of the layer 130, and the refractive index n3 of the layer 140 are substantially different from each other.

The number and configurations of FIG. 5 are given for illustrative purposes. Various implements are within the contemplated scope of the present disclosure. For example, in some embodiments, the number of layers in the film stack 510 is more than two.

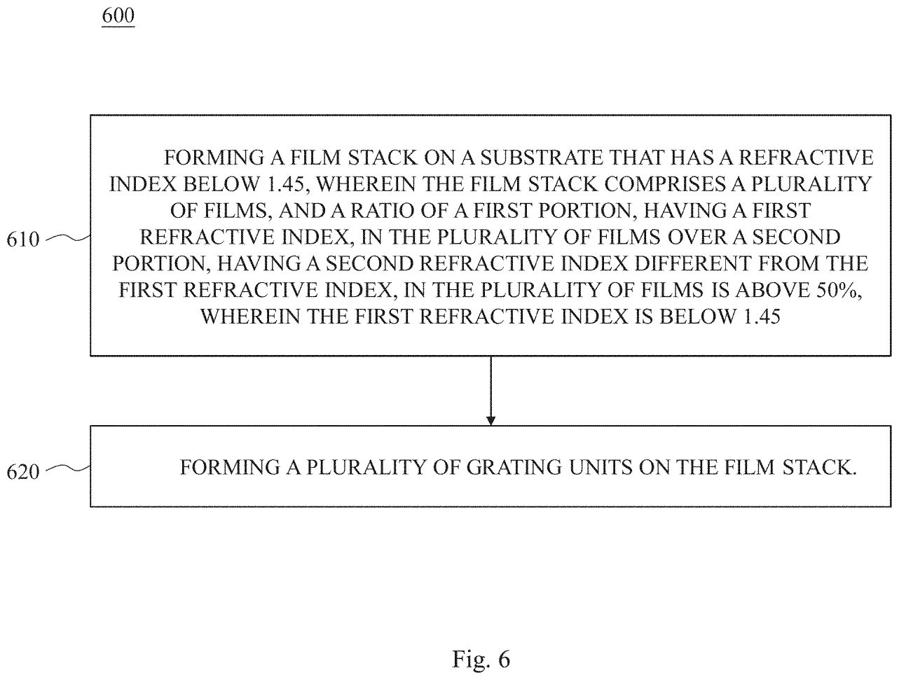

Reference is now made to FIG. 6. FIG. 6 is a flow chart of a method 600 of forming the diffraction optical element 20, 40, or 50, in accordance with some embodiments of the present disclosure. It is understood that additional operations can be provided before, during, and after the processes shown by FIG. 6, and some of the operations described below can be replaced or eliminated, for additional embodiments of the method. The order of the operations/processes may be interchangeable. Throughout the various views and illustrative embodiments, like reference numbers are used to designate like elements. The method 600 includes operations 610-620 that are described below with reference to the diffraction optical element 50 in FIG. 5.

In operation 610, the film stack 510 on the substrate 120 that has the refractive index n1 below 1.45. As shown in FIG. 5, the film stack 510 includes multiple films (e.g., the layers 130-140). One of the layers 130-140 is referred to as the first portion of the 510, and others are referred to as the second portion of the film stack 510. In some embodiments, a ratio of the first portion, for example, the layer 130 having the refractive index n2, in the film stack 510 over the second portion, for example, the layer 140 having the refractive index n3 different from the refractive index n2, in the film stack 510 is above 50%. The refractive index n2 is below 1.45.

In some embodiments, when the film stack 510 includes a number n of layers, in which n is an integer greater than n, layers having a refractive index below 1.45 are referred to as the first portion of film stack 510, and the layers having a refractive index above 1.45 are referred to as the second portion of film stack 510. In various embodiments, when the film stack 510 includes double layers of the layer 130 having the refractive index n2 below 1.45, the ratio of the low refractive index layer in the film stack 510 is determined to be 100%.

In some embodiments, the ratio of the first and second portions of the film stack 510 is determined according to thickness of the first portion and second portion. For example, as shown in FIG. 5, the ratio of the first portion (e.g., the layer 130) over the second portion (e.g., the layer 140) equals to h1/h2. In various embodiments, the thickness of the first portion in the film stack 510 is twice thicker than a thickness of the second portion in the film stack 510.

In some embodiments, the operations forming the film stack 510 further includes operations of patterning the film stack 510 according to the structure of the grating units 111 in the periodic structure 110. For example, instead of having single layer 130 in the diffraction optical element 40 of FIG. 4, in various embodiments, the diffraction optical element 40 further includes the layer 140 that is patterned to be disposed between two adjacent grating units 111 and above the corresponding layer 130.

In operation 620, the grating units 111 are formed on the film stack 510, as shown in FIG. 5.

Through the configurations of the various embodiments above, the diffraction optical elements and the method of forming the same provided by the present disclosure provide high dots efficiency of the diffraction optical element by utilizing a low refractive index substrate and/or at least one layer coated on the substrate.

It should be understood that, in this document and the following claims, unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

While the disclosure has been described by way of example(s) and in terms of the preferred embodiment(s), it is to be understood that the disclosure is not limited thereto. Those skilled in the art may make various changes, substitutions, and alterations herein without departing from the spirit and scope of the present disclosure. In view of the foregoing, it is intended that the present invention cover modifications and variations of this invention provided they fall within the scope of the following claims.

What is claimed is:

1. A diffraction optical element, comprising:
a substrate; and
a plurality of grating units that are disposed above the substrate, wherein the plurality of grating units are configured to diffract incident light to generate diffracted light being passing through the substrate;
wherein a refractive index of the substrate is substantially below 1.45.

2. The diffraction optical element of claim 1, further comprising:
a first layer that is sandwiched between the plurality of grating units and the substrate and extends below each of the plurality of grating units,
wherein the first layer has a first refractive index that is substantially below 1.45.

3. The diffraction optical element of claim 2, wherein a thickness of the first layer is associated with the first refractive index.

4. The diffraction optical element of claim 2, further comprising:
a second layer sandwiched between the first layer and the substrate, wherein the second layer has a second refractive index different from the first refractive index.

5. The diffraction optical element of claim 1, further comprising:
a layer that is patterned to be disposed between each two of the plurality of grating units and disposed on a surface of the substrate,
wherein a refractive index of the layer is substantially below 1.45.

6. The diffraction optical element of claim 1, further comprising:
a plurality of layers disposed between the plurality of grating units and the substrate, wherein at least half of the plurality of layers have a refractive index substantially below 1.45.

7. The diffraction optical element of claim 6, wherein the plurality of layers include layers of magnesium fluoride (MgF₂), silicon dioxide (SiO₂), or the combinations thereof.

8. The diffraction optical element of claim 1, further comprising:
a layer extending below each of the plurality of grating units, wherein the layer includes magnesium fluoride (MgF₂), silicon dioxide (SiO₂), or the combinations thereof.

9. A diffraction optical element, comprising:
a glass substrate;
a first layer disposed on the glass substrate, wherein the first layer has a first refractive index that is substantially below 1.45; and
a periodic structure disposed on the first layer;
wherein the glass substrate, the first layer, and the periodic structure are configured to diffract incident light from a first side of the glass substrate to generate diffracted light at a second side, opposite of the first side, of the glass substrate.

10. The diffraction optical element of claim 9, wherein the first layer includes magnesium fluoride (MgF₂) or silicon dioxide (SiO₂), and has a thickness of about 200 nanometers.

11. The diffraction optical element of claim 9, further comprising:
a second layer sandwiched between the first layer and the glass substrate, wherein the second layer has a second refractive index different from the first refractive index.

12. The diffraction optical element of claim 11, wherein the first and second layers include layers of magnesium fluoride (MgF₂), silicon dioxide (SiO₂), or the combinations thereof.

13. The diffraction optical element of claim 11, wherein the first layer has a first thickness and the second layer has a second thickness different from the first thickness.

14. The diffraction optical element of claim 9, wherein the glass substrate has a second refractive index;
wherein the diffractive optical element further comprises:
a second layer sandwiched between the first layer and the glass substrate, wherein the second layer has a third refractive index;
wherein the first to third refractive indices are different from each other and substantially below 1.45.

15. The diffraction optical element of claim 9, further comprising:
a second layer sandwiched between the first layer and the periodic structure, wherein the first layer includes magnesium fluoride (MgF₂) and the second layer includes silicon dioxide (SiO₂).

16. The diffraction optical element of claim 9, further comprising:
an adhesion film formed between the first layer and the periodic structure, wherein the adhesion film has a refractive index that is below 1.45.

17. A method of forming a diffraction optical element, comprising:
forming a film stack on a substrate that has a refractive index below 1.45, wherein the film stack comprises a plurality of films, and a ratio of a first portion, having a first refractive index, in the plurality of films over a second portion, having a second refractive index different from the first refractive index, in the plurality of films is above 50%,
wherein the first refractive index is below 1.45; and
forming a plurality of grating units on the film stack.

18. The method of claim 17, wherein the forming the film stack comprises:
patterning the film stack according to the structure of the plurality of grating units.

19. The method of claim 17, wherein the film stack includes magnesium fluoride (MgF₂), silicon dioxide (SiO₂), or the combinations thereof.

20. The method of claim 17, wherein a thickness of the first portion in the plurality of films is twice thicker than a thickness of the second portion in the plurality of films.
